(19) United States
(12) Patent Application Publication
(10) Pub. No.: US 2023/0157366 A1
(43) Pub. Date: May 25, 2023

(54) DELIVERY SYSTEM

(71) Applicant: Nicoventures Trading Limited, London (GB)

(72) Inventors: Scott George BOHAM, London (GB); Ping Chou CHEN, London (GB); Tom WOODMAN, London (GB)

(21) Appl. No.: 17/923,017

(22) PCT Filed: May 28, 2021
(86) PCT No.: PCT/GB2021/051316

§ 371 Date: Nov. 3, 2022

(30) Foreign Application Priority Data
May 29, 2020 (GB) 2008125.3
Jan. 29, 2021 (GB) 2101231.5

(51) Int. Cl. A24F 40/485

(52) U.S. Cl. CPC A24F 40/485; A24F 40/10

(57) ABSTRACT

There is provided a delivery system that includes a housing (6) having an opening (22) formed in a wall of the housing and through which a light source (29) within the housing can be seen. A battery (4) is contained within the housing so that the opening also functions as a vent to allow gases to escape from the housing through the opening, thereby preventing a build-up of pressure within the housing in the event that the battery is damaged In another embodiment, the housing (6) has an opening (22) in a wall of the housing through which lightfrom a light source (29) is visible and in which the opening is covered by a membrane (23). The membrane is such that the light is visible through the membrane.

### TECHNICAL FIELD

The present specification relates to a delivery system, such as a non-combustible aerosol provision system, or an aerosol-free delivery system.

### BACKGROUND

Smoking articles, such as cigarettes, cigars and the like burn tobacco during use to create tobacco smoke. Attempts have been made to provide alternative delivery systems to these articles by creating products that release compounds without combustion. Examples of such delivery systems are so-called “heat not burn” products or tobacco heating devices or products, which release compounds by heating, but not burning, a substrate. For example, tobacco heating devices heat an aerosol generating substrate, which may be tobacco or other non-tobacco products which may or may not contain nicotine, to form an aerosol by heating the substrate without burning it.

### SUMMARY

According to an aspect of the invention, there is provided a delivery device comprising a housing; an opening through a wall of the housing; a light source in the housing such that light emitted by the light source is visible through the opening, and a battery received in the housing, wherein the delivery device is configured such that the opening in the housing through which light from the light source is visible is a vent for the egress of gas from the housing.

The delivery device may have a membrane formed from a gas permeable material that extends over the opening and through which light emitted by the light source is visible. The membrane can be made from, or be coated with, a material that diffuses light emitted by the light source. The membrane may be formed from a material that is substantially impermeable to liquid. The membrane may have a pore size in the region of 0.6 μm. The membrane may have a thickness of between 0.11 mm-0.19 mm. The membrane can have a venting capacity of 1900-2400 ml/cm²/min at a pressure of 7 kpa.

The membrane may be attached to an inner surface of the housing.

The battery may be received in a carrier having open regions to enable gas emitted by the battery to circulate within the housing around the carrier.

The delivery device may comprise a circuit board mounted to the battery within the housing. In this case, the light source may be mounted to the circuit board and spaced from the opening.

The delivery device may comprise a light transmitting element on the circuit board. The light transmitting element may be positioned between the circuit board and the opening in the wall of the housing.

The light transmitting element may upstand towards, but remain spaced from, the opening to form a pressure relief gap between the light transmitting element and the wall of the housing around the opening.

If there is a membrane over the opening, which is attached to the inside of the housing so as to extend over the opening, the light transmitting element may upstand towards the membrane.

The light transmitting element has an upper surface that may face the membrane.

The upper surface of the light transmitting element may be close to, but spaced from, the membrane to form a pressure relief gap between the upper surface of the light transmitting element and the membrane.

In some embodiments, the upper surface of the light transmitting element may comprises regions that lie in contact with the membrane.

The regions of the upper surface in contact with the membrane may lie in contact at least a part of the periphery of the membrane that lies in contact with the housing.

The light transmitting element may be made from a resiliently deformable material.

The light transmitting element may be configured so that it assumes a deformed condition between the circuit board and the membrane, when located in the housing, so that the light transmitting element applies a biasing force against the membrane to push it against the housing.

The light transmitting element may be positioned so that it extends over the light source, and may have a recess in which the light source on the circuit board is received.

The light transmitting element may have an opening to additionally allow light from the light source to pass through the opening in the light transmitting element.

The delivery device may comprise a substrate aerosolising module including a heater and an aerosolisable substrate, the substrate aerosolising module being configured to aerosolise the substrate in response to a control signal from the control module.

According to another aspect of the invention, there is provided a delivery device comprising a housing; an opening in the housing; a light source in the housing such that light emitted by the light source is visible through the opening, and a membrane extending over the opening through which light emitted by the light source is visible.

The membrane may be made from, or is coated with, a material that diffuses light emitted by the light source.

In any embodiment, the housing comprises a sleeve which is closed by an end cap.

### BRIEF DESCRIPTION OF THE DRAWINGS

Example embodiments will now be described, by way of example only, with reference to the following schematic drawings, in which:

FIG. 1 is a schematic drawing of a device in accordance with an example embodiment;

FIG. 2 is an exploded view of a control module of the device shown in FIG. 1;

FIG. 3 is a cross-sectional view of the assembled control module of FIGS. 1 and 2;

FIG. 4 is an enlarged view of a portion (encircled as X in FIG. 3) of the assembled control module of FIG. 3; and

FIG. 5A to 5C shows a top perspective, side cross-sectional and bottom views, respectively, of the membrane support.

### DETAILED DESCRIPTION

As used herein, the term “delivery system” is intended to encompass systems that deliver at least one substance to a user, and includes: non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

Embodiments according to the invention provide a delivery system that includes a housing having an opening formed in a wall of the housing and through which a light source within the housing, such as a light emitting diode (LED), can be seen. A battery is contained within the housing so that the opening also functions as a vent to allow gases to escape from the housing through the opening, thereby preventing a build-up of pressure within the housing in the event that the battery is damaged. The opening therefore provides a dual function of providing a window through which the LED or light source can be seen, as well as a vent opening. In any embodiments of the invention, there may also be a membrane extending across the opening. Light emitted by an LED or light source positioned beneath the membrane is transmitted, and so is visible, through the membrane.

In another embodiment of the invention, the housing has an opening in a wall of the housing through which light from a light source is visible and in which the opening is covered by a membrane. The membrane is such that the light is visible through the membrane. For example, the membrane may be made of light transmissive material and/or a material that diffuses light from the light source.

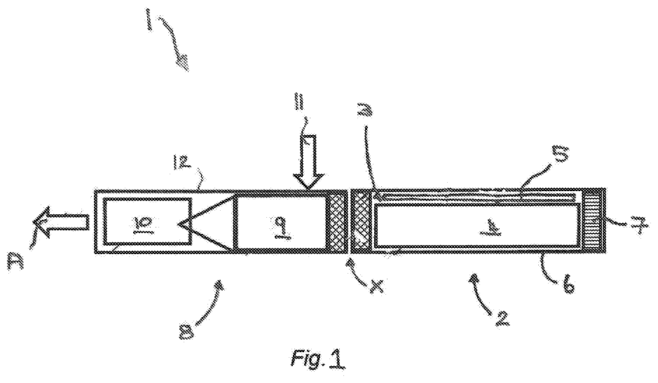

FIG. 1 is a schematic drawing of a delivery system 1 in the form of a non-combustible aerosol provision or delivery device 1. The device 1 comprises two main components 2, 8.

The first component 2 of the device 1 includes a control module 3, which includes a battery 4 and a circuit board 5. The control module 3 is received within a housing 6 which encloses the control module 3 and forms the external appearance of the device 1. The housing 6 may be a tubular sleeve, in which case the control module 3 is inserted into the housing 6 from one open end during assembly of the device and the open end of the housing 6 is then closed by an end cap 7. However, the housing 6 may, alternatively, be formed from multiple parts or shells that are attached together to form an enclosure around the control module 3. If the housing 6 is formed from two half-shells, for instance, the control module 3 may be placed in one half-shell part before the other half-shell part is placed on, and is attached to, the other half-shell part thereby encapsulating the control module 3 within the housing 6. The housing 6 is preferably formed from a metal, such as aluminium, although other materials for the housing 6 are also possible.

The second component 8 of the device 1 includes a heater 9 and a liquid reservoir 10 that may collectively form an aerosol generating module. The first and second components 2, 8 may be modular, i.e. the second component 8 may have its own housing 12 and be separable from the first component (at a join marked X in FIG. 1) for repair or replacement. A releasable electrical connection joins the first and second components 2, 8 to enable power and control signals to be transmitted between them. However, the first and second components 2, 8 may not be separable, other than by disassembly of the device 1. More specifically, the first and second components 2, 8 may be connected together during assembly and received within the same integral housing 6 to form an integral unit.

When the device of FIG. 1 is used, air is drawn into an air inlet of the heater 9, as indicated by the arrow 11. The heater 9 is controlled by the control module 3 and heats the incoming air. The heated air is directed to the liquid reservoir 10, where an aerosol is generated. The aerosol exits the device 1 at an air outlet, as indicated by the arrow A, into the mouth of a user of the device 1.

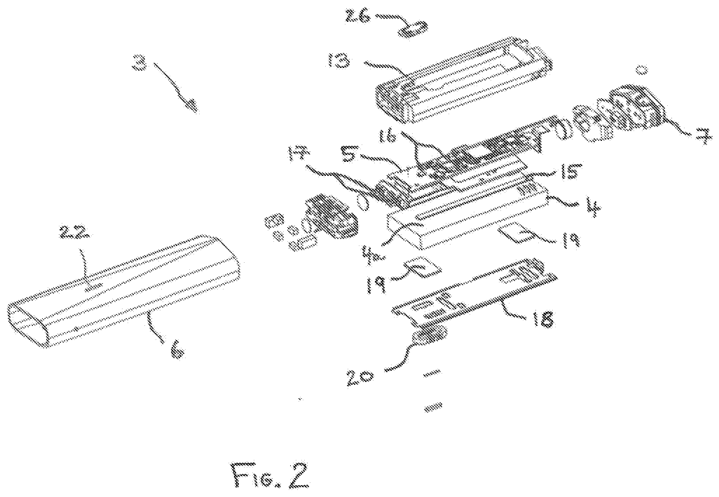

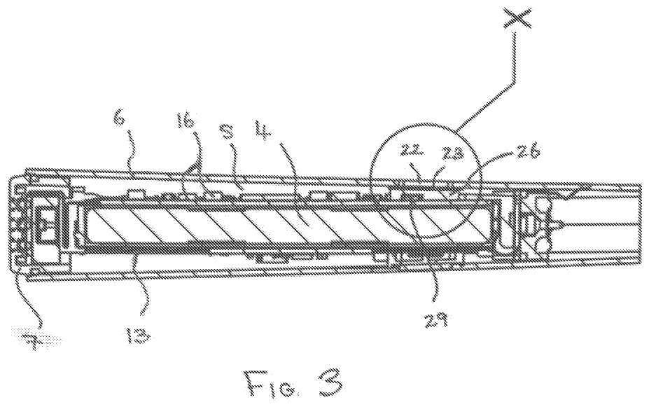

FIG. 2 is an exploded view of the control module 3 shown in FIG. 1, with the second component 8 omitted, and FIG. 3 is a cross-sectional view of the control module 3 of FIG. 2 once assembled and received within the housing 6. In the embodiment of FIG. 2, it can be seen that the housing 6 is in the form of a sleeve and the remaining components of the control module 3 are inserted into the housing 6 from one end. The end is then closed by an end cap 7 to seal the housing 6.

As shown in FIG. 2, and also in FIG. 3 which shows a cross-sectional assembled view of device 1, the control module 3 includes a frame or carrier 13 in which the battery 4 is received and held. A circuit board 5 is mounted to the top outside surface of the carrier 13 and is supported by both the carrier 13 and by the outside of one major face 4a of the battery 4. An insulated spacer or support pad 15 may be located between the major face 4a of the battery 4 and the circuit board 5 where they overlie each other. The support pad 15 may be adhesive, so that the circuit board 5 is held in place on the major face 4a of the battery 4 by the adhesive pad 15. Various electrical circuit and control elements 16 are mounted to the circuit board 5, which also has connectors 17 for electrical connection of the circuit board 5 to the aerosol generating module of the second component 8. These connectors 17 are positioned on a section of the circuit board 5 that overhangs one end of the carrier 13.

A metal or conductive plate 18 is mounted to the underside of the carrier 13 and to the other major face 4b of the battery 4 on the opposite side of the battery 4 to the circuit board 5. An insulated pad 19 or spacer may be located between the other major face 4b of the battery 4 and the metal plate 18 and may be adhesive so that the metal plate 18 is held in place on the other major face 4b of the battery 4. The metal plate 18 forms an electrical connection between the battery 4 and the circuit and control elements 16 on the circuit board 5. It will be understood that the carrier 13 is open, in the sense that it does not completely cover or surround the battery 4. Even with the circuit board 5 and metal plate 18 mounted to the carrier 13 and extending over the major faces 4a, 4b of the battery 4, the battery 4 is still partially exposed. This enables any heat or gases generated by the battery 4, which may occur either as a result of normal use, or due to a malfunction, to escape into regions of the housing 6 that surround the battery 4, rather than being trapped within the carrier 13.

The control module 3 includes a press button on/off switch 20, which is mounted to the metal plate 18 and is accessible through an aperture in the housing 6. Pressing the on/off switch 20 connects, or disconnects, the battery 4 from the circuitry 16 on the circuit board 5, thereby switching the device on or off, or performing other control functions as required.

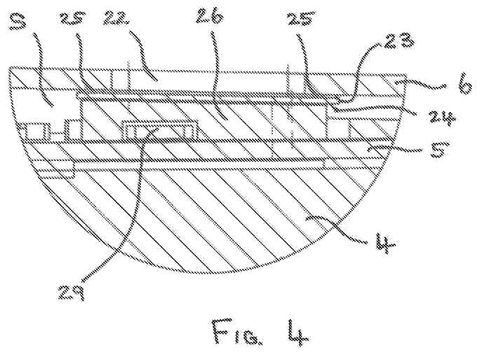

As can be seen most clearly in FIGS. 3 and 4, the carrier 13, together with the battery 4 and circuit board 5 mounted thereto, is received within the housing 6 such that there is a space ‘S’ between the circuit board 5 and the wall of the housing 6 into which heat or gases generated by the battery 4 may dissipate internally. Electrical circuit and control components 16 that are mounted on the circuit board 5 occupy this space.

It is common for delivery devices 1 to have a light source such as a light-emitting diode (LED) 29 so that a user can tell if the device is powered, or to signal other functions such as the need for charging of the battery 4. In the majority of known devices, the LED is provided on the circuit board 5 and an opening 22 is provided in the housing 6 through which the LED 29 can be seen, or in which the LED 29 is located. For this purpose, the opening 22 and the LED 29 on the circuit board 5, are positioned so that they are in alignment when the device 1 is assembled., i.e. the LED 29 is positioned beneath the opening 22. An LED 29 mounted to the circuit board 5 beneath the opening 22 is shown in FIGS. 3 and 4. In other embodiments, the LED 29 is positioned offset from the opening 22 and is not directly beneath the opening 22.

In accordance with some embodiments of the invention, the opening 22 is covered by a membrane 23 which has properties that enable it to act as a light guide to diffuse light from the LED 29. In certain embodiments, the membrane 23 may be made from a light transmissive material. Alternatively, it may be coated with an optical film, such as a diffuser film or light control film, to improve its performance as a light guide.

The membrane 23 is attached to the housing 6 over the opening. In particular, the membrane 23 is attached to the inside surface of the housing 6 so that it is recessed from the external surface of the housing 6 by the thickness of the housing 6 making it less accessible and so better protected. Preferably, the membrane 23 is larger than the opening 22 and so has a peripheral region 24 that extends beyond the opening and faces the inside surface of the housing 6. A permanent adhesive 25 is applied to this peripheral region 24 in an annular pattern around the entire peripheral region, and attaches the membrane 23 to the housing 6 so that it is held against the housing 6 and extends across the opening 22.

As the housing 6 is a sealed unit once assembled, gas may collect within the housing 6 resulting in a build-up of pressure. Therefore, the opening in the housing 6, irrespective of whether or not a membrane 23 extends over it, may also act as a vent to enable any gases to escape and to maintain a nominal or atmospheric pressure within the device 1. The opening 22 also allows air to circulate into and out of the housing 6 to minimise any temperature differences.

If the opening 22 also acts as a vent, the membrane 23 may be omitted altogether. If a membrane 23 is used, then it must be sufficiently permeable to allow air and/or gas to pass through it with little or no resistance. However, the membrane 23 may also be waterproof or at least have a degree of water resistance. For example, and with reference to the IP standard drawn up by the International Electrotechnical Commission (IEC), the device 1 may have what is commonly referred to as an ‘IP67 rating’, which means that it is resistant to the seeping of dust or dirt into the device 1, which includes access through the membrane 23. This rating also means that the device 1 can be submerged in fresh water to a depth of up to 1.5 metres for a period of half an hour, without the water penetrating the device 1, and so the membrane 23 covering the vent 22 in the housing 6 needs to be able to prevent such penetration.

To allow for the passage of gas or air, it is envisaged that the membrane 23 may have a hole size of 0.65 μm, and a thickness of between 0.11 mm-0.9 mm, with a venting capacity of 1900-2400 ml/cm²/min at a pressure of 7 kpa, in addition to acting as a light guide to diffuse light emitted by the LED. One such material that meets these requirements is made by Dong Guan PUW EPTFE Material Co,. Ltd, under product No. PUW867.

A gap or spacing ‘S’ exists between the circuit board 5 and the membrane 23. Although this gap relatively small, any foreign object or a finger inserted through the vent 22 in the housing 6 and which applies pressure to the membrane 23 may cause the membrane 23 to rupture or the adhesive 25 to fail, resulting in the membrane 23 becoming detached from the housing 6. Furthermore, as the LED 29 is positioned beneath the membrane, the LED 29 may also be damaged. Therefore, in certain embodiments that include a membrane 23 may also include a membrane support 26 located between the membrane 23 and the circuit board 5. Preferably, the membrane support 26 is mounted to the circuit board 5 and upstands in a direction towards the membrane 23.

The membrane support 26 extends over the LED 29 on the circuit board 5 and has a recess 31 formed between feet 32 in which the LED 29 is received when the membrane support 26 is mounted to the circuit board 5. The membrane support 26 may be made of a light transmissive material and be a light transmitting element, so that light can pass through it from the LED 29, and through the membrane 23, so that it is visible from outside the housing 6. In addition, or alternatively, the membrane support 26 may have an opening 31 positioned in the vicinity of the LED 29 such that light from the LED 29 can pass through the opening 31, through the membrane 23, and be visible to a user from outside the device 1.

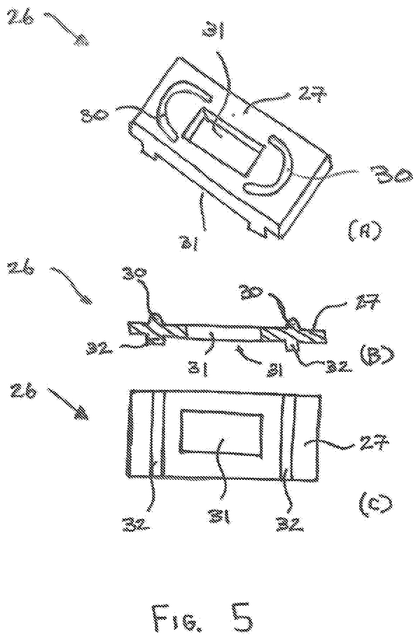

A more detailed version of the membrane support 26 is shown in FIG. 5A to 5C, and from which it can be seen that the membrane support 26 has an upper surface 27 that faces, and which may lie in contact with, the underside of the membrane 23, at least beneath a portion of the membrane 23 which extends across the opening. If the upper surface 27 of the membrane support 26 lies in contact with the membrane 23, the upper surface 27 of the membrane support 26 may have regions that are not in contact with the membrane 23 so that spaces remain through which gas can pass over the upper surface 27 of the support 26, and through the membrane 23 and opening 22. In particular, and as shown in FIGS. 5A and B, the membrane support 26 may have raised areas 30 upon which the membrane 23 sits. The raised areas 30 form a space between the membrane 23 and the upper surface 27. The raised areas 30 extend about only part of the vent 22 to allow gas to escape between the upper surface 27 and the membrane 23 and pass through the vent 22.

If a membrane support 26 is provided, and pressure is applied to the membrane 23 through the opening 22 by a user, the membrane 23 is pressed against, and so supported by, the upper surface 27 or regions of the upper surface 28 of the membrane support 26 with little or no deflection, thereby preventing any damage to the membrane 23 or detachment of the membrane 23 from the housing 6. Damage to the LED 29 is also prevented.

The membrane support 26 may be made from a deformable or flexible material, such as rubber, and it may be sized so that, when positioned in the housing 6, it is deformed or squashed between the circuit board 5 and the membrane 23. The membrane support 26 has a degree of resilience such that, once deformed, it applies a biasing force to the membrane 23 that pushes the membrane 23 against the housing 6, i.e. the peripheral region 24 of the membrane 23 which is glued to the housing 6 is pushed against the housing 6 by the membrane support 26. The membrane support 26 therefore also holds the membrane 23 in place, in addition to the adhesive 25. In some embodiments, it may be found that the membrane 23 can be held in place only by the membrane support 26, in which case the membrane 23 need not be glued or otherwise attached to the housing 6. It is also possible for the membrane 23 to be glued or otherwise attached to the membrane support 26 which is then urged against the housing 6 by the deformation and resilience of the membrane support 26. It will be understood that the membrane support 26 resists a degree of pressure if a force is applied to the membrane 23 through the vent 22, prior to any deformation or substantial deformation of the membrane support 26.

It will be appreciated, particularly from FIG. 4, that the housing 6 may narrow from one end towards the other. In this instance, the membrane support 26 may also be thinner at one end, i.e. its upper surface 27 may be angled so that it is parallel to the membrane 23 and the housing wall.

As the opening is used as a window through which the LED 29 can be seen, with the membrane 23 acting as a light diffuser, and the opening 22 can also provide a vent, with the membrane 23 having gas permeable properties, the number of openings that need to be provided in the housing 6 is reduced.

Although reference is made to a membrane support 26, it will be understood that a support may be used in the absence of a membrane 23. The support 26 may be made from a light transmissive material. It may upstand from the circuit board 5 towards the opening 22, and can be spaced from the opening 22 to provide a pressure relief gap between the upper surface of the support 26 and the wall of the housing 6 to allow gas to escape from the housing 6 through the gap and the opening 22 in the housing 6.

In other embodiments, the membrane support 26 may be formed from a rigid material when deployed with the membrane 23. The membrane support 26 may be formed from any material in which the membrane support 26 has a higher rigidity than the membrane 23. Preferably, the membrane is made from silicone or like material.

The thickness of the membrane 23 may be larger than the pressure relief gap between the upper surface 27 of the membrane support 26 and the wall of the housing 6 surrounding the vent 22. The thicker membrane 23 may be formed from an elastically deformable material such that the thicker membrane 23 is compressible and deforms when the membrane 23 is squeezed by the membrane support 26 against the wall of the housing 6 surrounding the vent 22. The biasing force applied against the membrane 23 by the membrane support 26 to push the membrane 23 against the housing 6 is increased since the thickness of the membrane 23 is larger than the pressure relief gap. In this situation, the membrane 23 will be further forced against the housing 6 by the rigidity of the membrane support 26 and the device 1 will have increased protection from the possible ingress of water through the vent 22 due to the tighter fit of the membrane 23 around the vent 22.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A delivery device comprising:
a housing;
an opening through a wall of the housing;
a light source in the housing such that light emitted by the light source is visible through the opening, and
a battery received in the housing,
wherein the delivery device is configured such that the opening in the housing through which light from the light source is visible is a vent for the egress of gas from the housing.

2. A delivery device according to claim 1, wherein a membrane, formed from a gas permeable material, extends over the opening and through which light emitted by the light source is visible.

3. A delivery device according to claim 2, wherein the membrane is made from, or is coated with, a material that diffuses light emitted by the light source.

4. A delivery device according to claim 2, wherein the membrane is formed from a material that is substantially impermeable to liquid

5. A delivery device according to claim 2, wherein the membrane has a pore size in the region of 0.65 μm.

6. A delivery device according to claim 2, wherein the membrane has a thickness of between 0.11 mm-0.19 mm.

7. A delivery device according to claim 2, wherein the membrane has a venting capacity of 1900-2400 ml/cm²/min at a pressure of 7 kpa.

8. A delivery device according to claim 2, wherein the membrane is attached to an inner surface of the housing.

9. A delivery device according to claim 1, wherein the battery is received in a carrier having open regions to enable gas emitted by the battery to circulate within the housing around the carrier.

10. A delivery device according to claim 1, comprising a circuit board mounted to the battery within the housing, the light source being mounted to the circuit board and spaced from the opening.

11. A delivery device according to claim 10, comprising a membrane support element on the circuit board, the membrane support element being positioned between the circuit board and the opening in the wall of the housing.

12. A delivery device according to claim 11, wherein the membrane support element upstands towards, but is spaced from, the opening to form a pressure relief gap between the membrane support element and the wall of the housing around the opening.

13. A delivery device according to claim 11, when dependent on any of claims 2 to 8, wherein the membrane is attached to the inside of the housing so as to extend over the opening and the membrane support element upstands towards the membrane.

14. A delivery device according to claim 13, wherein the membrane support element has an upper surface facing the membrane.

15. A delivery device according to claim 14, wherein the upper surface of the membrane support element is close to, but spaced from, the membrane to form a pressure relief gap between the upper surface of the membrane support element and the membrane.

16. A delivery device according to claim 15, wherein the upper surface of the membrane support element comprises regions that lie in contact with the membrane.

17. A delivery device according to claim 16, wherein the regions of the upper surface in contact with the membrane lie in contact at least a part of the periphery of the membrane that lies in contact with the housing.

18. A delivery device according to claim 17, wherein the membrane support element is made from a resiliently deformable material.

19. A delivery device according to claim 18, wherein the membrane support element is configured so that it assumes a deformed condition between the circuit board and the membrane, when located in the housing, so that the membrane support element applies a biasing force against the membrane to push it against the housing.

20. A delivery device according to claim 17, wherein the membrane support element is made from a material that has a greater rigidity than the membrane.

21. A delivery device according to claim 20, wherein the thickness of the membrane is larger than the pressure relief gap between the membrane support element and the wall of the housing surrounding the opening.

22. A delivery device according to claims 12, wherein the membrane support is a light transmitting element positioned so that it extends over the light source, the light transmitting element having a recess in which the light source on the circuit board is received.

23. A delivery device according to claim 22, wherein the light transmitting element has an opening to additionally allow light from the light source to pass through the opening in the light transmitting element.

24. A delivery device according to claim 1, comprising a substrate aerosolising module including a heater and an aerosolisable substrate, the substrate aerosolising module being configured to aerosolise the substrate in response to a control signal from the control module.

25. A delivery device comprising:
a housing;
an opening in the housing;
a light source in the housing such that light emitted by the light source is visible through the opening, and
a membrane extending over the opening through which light emitted by the light source is visible.

26. A delivery device according to claim 25, wherein the membrane is made from, or is coated with, a material that diffuses light emitted by the light source.

27. A delivery device according to claim 25, comprising a membrane support element positioned between the light source and the opening.

28. A delivery device according to claim 27, wherein the membrane support element is made from a material having a greater rigidity than the membrane and upstands towards, but is spaced from the opening, to form a pressure relief gap between the membrane support element and a wall of the housing around the opening.

29. A delivery device according to claim 28, wherein the thickness of the membrane is larger than the pressure relief gap between the membrane support element and the wall of the housing surrounding the opening.

30. A delivery device according to claim 25, wherein the membrane support element is a light transmitting membrane support element.

31. A delivery device according to claim 1, wherein the housing comprises a sleeve which is closed by an end cap.
